(19) United States
(12) Patent Application Publication
(10) Pub. No.: US 2024/0231702 A1
(43) Pub. Date: Jul. 11, 2024

(54) MULTIPLANE DATA TRANSFER COMMANDS

(71) Applicant: Micron Technology, Inc., Boise, ID (US)

(72) Inventors: Giuseppe Cariello, Boise, ID (US); Fulvio Rori, Boise, ID (US)

(21) Appl. No.: 18/542,388

(22) Filed: Dec. 15, 2023

Related U.S. Application Data
(60) Provisional application No. 63/438,447, filed on Jan. 11, 2023.

(51) Int. Cl. G06F 3/06

(52) U.S. Cl. CPC G06F 3/0659; G06F 3/0604; G06F 3/0679

(57) ABSTRACT

Methods, systems, and devices for multiplane data transfer commands are described. Implementations may provide a modified transfer command to leverage a sequential nature of a read operation. For example, a memory system may determine to read data stored across a set of planes of a non-volatile memory device and a sequence of the planes may be known. The memory system may issue a transfer command to a controller of the non-volatile memory device that supports automatic switching from one plane to the next in transferring data from the set of planes to a controller of the memory system. As a result, one transfer command may be issued by the memory system controller to transfer the data from the set of planes, for example, rather than one transfer command per plane.

### CROSS REFERENCE

The present Application for Patent claims priority to U.S. Provisional Patent Application No. 63/438,447 by Cariello et al., entitled “MULTIPLANE DATA TRANSFER COMMANDS” filed Jan. 11, 2023, which is assigned to the assignee hereof, and which is expressly incorporated by reference herein.

### FIELD OF TECHNOLOGY

The following relates to one or more systems for memory, including multiplane data transfer commands.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports multiplane data transfer commands in accordance with examples as disclosed herein.

FIG. 2 illustrates an example of a system that supports multiplane data transfer commands in accordance with examples as disclosed herein.

FIG. 3 illustrates an example of a system that supports multiplane data transfer commands in accordance with examples as disclosed herein.

FIG. 4 illustrates an example of a command sequence that supports multiplane data transfer commands in accordance with examples as disclosed herein.

FIG. 5 illustrates an example of a data transfer diagram that supports multiplane data transfer commands in accordance with examples as disclosed herein.

FIG. 6 illustrates an example of a data transfer diagram that supports multiplane data transfer commands in accordance with examples as disclosed herein.

FIG. 7 illustrates a block diagram of a memory system that supports multiplane data transfer commands in accordance with examples as disclosed herein.

FIG. 8 illustrates a flowchart showing a method or methods that support multiplane data transfer commands in accordance with examples as disclosed herein.

### DETAILED DESCRIPTION

Methods, systems, and devices for memory, including multiplane data transfer commands, are described. In some memory systems, such as managed NAND (MNAND) and solid-state drive (SSD) memory systems, among others, sequential read performance may be limited by the speed of an interface between non-volatile and volatile memory devices of the memory system. Normally the speed of the interface (e.g., the quantity and the speed of internal open NAND flash interface (ONFI) channels) is sufficient to saturate a speed at which a host system communicates with the memory system, but the low-cost and low-density versions of a memory system are sometimes limited by interface speed (e.g., ONFI channel speed and quantity). In some cases, performance of a memory system may correspond to a quantity of data transmitted in a unit of time. As such, interface (e.g., ONFI) efficiency may be the percentage of time in which the channel is transmitting data. Even in an ideal case, in which a channel is never left idle, the efficiency may be limited by the time used to send commands (e.g., sense commands, status polling, and column address changes, among other commands) as a part of (e.g., before, during) data transfer.

A non-volatile memory device, such as a NAND memory device, may include multiple planes of memory cells. A memory system may include an interface (e.g., a data pipeline, internal ONFI channels) via which data may be communicated between the non-volatile memory device and a memory system controller (e.g., a volatile memory device of the memory system controller, such as a static random access memory (SRAM) device, among others). In some examples, data may be sequentially read from the multiple planes. As part of the sequential read, data from the planes may, in some cases, be transferred to the memory system controller via the interface in response to transfer commands issued by the memory system controller to a controller of the non-volatile memory device. In some cases, however, a separate transfer command may be issued each time that data from a different plane is to be transferred to the memory system controller. This may increase a signaling overhead associated with transferring the data via the interface, which may increase a latency in performing the sequential read and reduce interface efficiency.

Implementations described herein address the aforementioned shortcomings and other shortcomings by providing a modified transfer command to leverage the sequential nature of the read. For example, a memory system may determine to read data stored across a set of planes of a non-volatile memory device of the memory system and a sequence according to which the planes are read may be known (e.g., stored based on writing the data sequentially to the planes). The memory system may issue a command to sense (e.g., read, retrieve, transfer) the data from the planes to an interface for communicating the data between the non-volatile memory device and a memory system controller. The memory system may issue a single transfer command that supports the transfer of the data stored across the set of planes from the interface to the memory system controller. For example, the transfer command may include an indication to automatically switch from one plane to the next in transferring the data to the memory system controller via the interface. As a result, one transfer command may be issued by the memory system controller to transfer the data from the set of planes via the interface rather than one transfer command per plane, which will reduce command signaling overhead, increase interface efficiency, and reduce read operation latency, among other benefits.

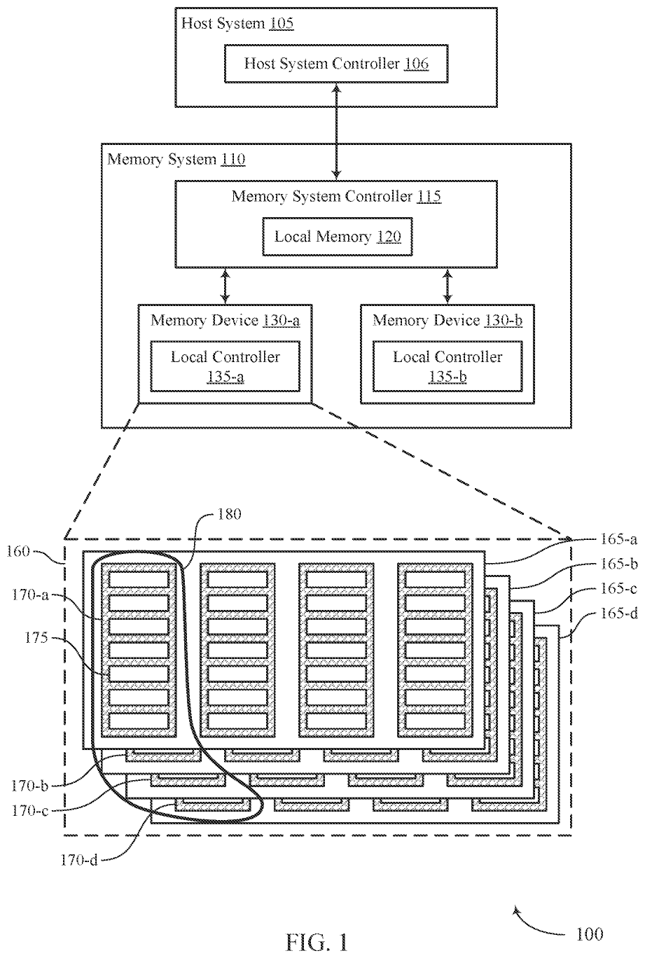

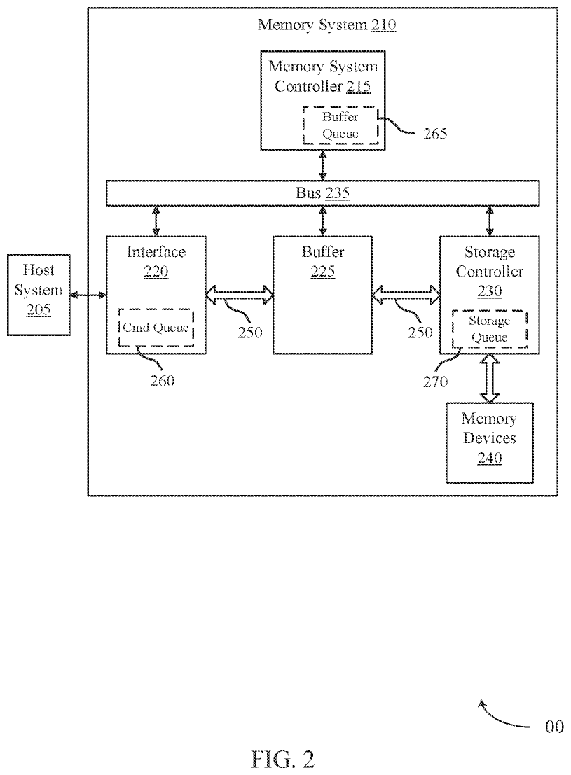

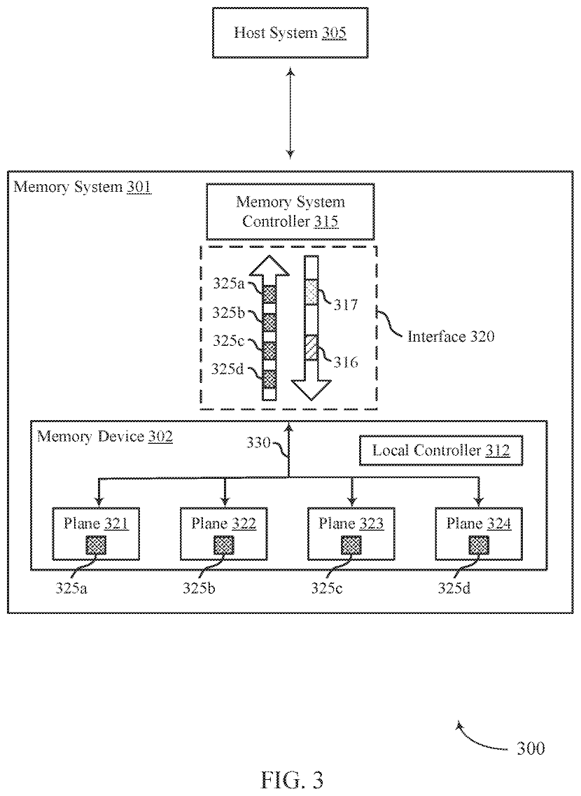

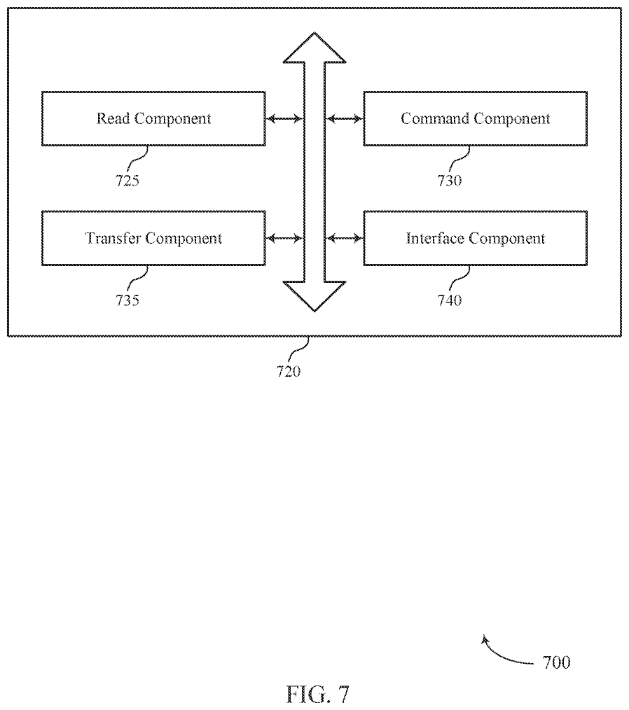

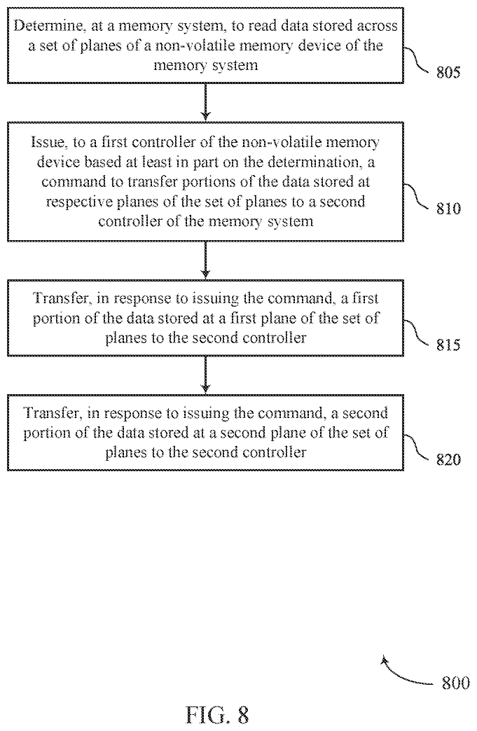

Features of the disclosure are initially described in the context of systems with reference to FIGS. 1 through 2. Features of the disclosure are described in the context of non-volatile memory devices utilizing multiplane data transfer commands with reference to FIGS. 3 through 6. These and other features of the disclosure are further illustrated by and described in the context of an apparatus diagram and flowchart that relate to multiplane data transfer commands with reference to FIGS. 7 and 8.

FIG. 1 illustrates an example of a system 100 that supports multiplane data transfer commands in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a universal flash storage (UFS) device, an embedded multi-media controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a fiber channel interface, a small computer system interface (SCSI), a serial attached SCSI (SAS), a double data rate (DDR) interface, a DIMM interface (e.g., DIMM socket interface that supports DDR), an open NAND flash interface (ONFI), and a low power double data rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory. ROM, phase change memory (PCM), self-selecting memory, other chalcogenide-based memories, ferroelectric random access memory (RAM) (FeRAM), magneto RAM (MRAM), NOR (e.g., NOR flash) memory, spin transfer torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a. 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases. NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wear out considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support multiplane data transfer commands. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples, the memory system 110 may support a read operation in which data from multiple planes 165 is read. For example, the memory system 110 may support reading one or more pagelines of data, where a pageline refers to a single row of pages 175 of a virtual block 180. For instance, a pageline corresponding to a first row of a virtual block 180 may include the first page 175 of each block 170 of a group of blocks 170 included in the virtual block 180. To read a pageline of data, the memory system 110 may read data from a page 175 of a first plane 165 (e.g., the plane 165-a), then data from a page 175 of a second plane 165 (e.g., the plane 165-b) and so on until each of the pages 175 of the row of the virtual block 180 are read. In some examples, data from a plane 165 is sensed (e.g., read, retrieved, transferred) to an interface for communicating data between a memory device 130 and the memory system controller 115, where the data is temporarily held before being transferred to the memory system controller 115 in response to transfer commands issued by the memory system controller 115 to the memory device 130 (e.g., a local controller 135).

In some cases, transfer commands may be issued to change from which of the multiple planes data is transferred during a series of sequential read operations (e.g., one or more read operations to read one or more pagelines of data). The memory system controller 115 may utilize a respective change column command (e.g., a transfer command) between respective read operations of a series of sequential read operations from each plane 165 to indicate the plane 165 from which corresponding sensed data is to be transferred, thereby resulting in the requested data being obtained using the combination of data from these multiple sequential read operations. However, the issuance and execution of the multiple change column commands may add overhead to the accessing of data read from multiple planes 165.

In accordance with examples described herein, the memory system 110 may issue a single transfer command that supports multiple plane 165 data transfer via the interface. For example, the memory system 110 (e.g., the memory system controller 115) may issue one or more sense commands to a local controller 135 of a memory device 130 to transfer one or more pagelines of data to the interface. The memory system 110 may also issue a transfer command to the local controller 135 to transfer the data to the memory system controller 115 via the interface. The data may be written to the planes 165 of the one or more pagelines sequentially and may be read according to the order that it was written. The transfer command may include an indication to automatically switch from one plane 165 to the next in accordance with the order such that the sensed data stored across multiple planes 165 may be transferred to the memory system controller 115 via the interface in response to the transfer command (e.g., rather than one transfer command per plane 165).

FIG. 2 illustrates an example of a system 200 that supports multiplane data transfer commands in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory. 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address in the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

Once the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

In some cases, the memory system controller 215 may issue multiple transfer commands to change from which of multiple planes (e.g., planes 165) data is transferred during a series of sequential read operations. The memory system controller 215 may utilize a respective change column command (e.g., a transfer command) between respective read operations of a series of sequential read operations from each plane to indicate the plane from which corresponding sensed data is to be transferred, thereby resulting in the requested data being obtained using the combination of data from these multiple sequential read operations. However, the issuance and execution of the multiple change column commands may add overhead to the accessing of data read from multiple planes.

In accordance with examples described herein, the memory system controller 215 may issue a single transfer command that supports multiple plane data transfer via the interface. For example, the memory system controller 215 may issue one or more sense commands to the storage controller 230 to transfer one or more pagelines of data to the interface. The memory system controller 215 may issue a transfer command to the storage controller 230 to transfer the data to the memory system controller 215 via the interface. The data may be written to the planes of the one or more pagelines sequentially and may be read according to the order that it was written. The transfer command may include an indication to automatically switch from one plane to the next in accordance with the order such that the sensed data stored across multiple planes may be transferred to the memory system controller 215 via the interface in response to the transfer command (e.g., rather than one transfer command per plane).

FIG. 3 illustrates an example of a system 300 that supports multiplane data transfer commands in accordance with examples as disclosed herein. The system 300 may implement or be implemented by aspects of the systems 100 and 200 described with reference to FIGS. 1 and 2. For example, the system 300 may include a host system 305 and a memory system 301, which may be examples of the corresponding systems described herein, including with reference to FIGS. 1 and 2.

In FIG. 3, host system 305 may be coupled with the memory system 301 to enable the host system 305 to read data from and write data to one or more memory devices 302 of the memory system 301 (e.g., memory devices 130, 240). The memory system 301 may include a memory system controller 315 and one or more memory devices 302. The memory system 301 may support reading data stored to the memory devices 302 for various purposes, such as in response to read commands issued by the host system 305 or as part of a media management operation. For example, the host system 305 may issue a read command to the memory system 301 (e.g., the memory system controller 315) causing the memory system controller 315 to obtain the requested data from the memory device 302 and transmit the data to the host system. Additionally or alternatively, the memory system controller 315 may read data from the memory device 302 as part of a media management operation to transfer the data between memory devices 302 or between respective portions of the memory device 302 (e.g., pages, blocks, virtual blocks, planes, and the like) In some examples, a series of read operations may utilize non-contiguous logical addresses for each of the individual read operations. In some other examples, a series of read operations may utilize a series of sequential logical addresses.

A series of read operations (e.g., or a single read operation) may cause data 325 to be obtained from multiple planes, such as planes 321-324, that are within the memory device 302. The memory device 302 may include a local controller 312 and any quantity of planes, such as planes 321-324. The local controller 312 may receive a command issued by the memory system controller 315 to obtain a block of data from the planes 321-324 via an interface 320. For example, the memory system 301 may include an interface 320 via which information may be communicated between the memory system controller 315 and the memory device 302. In some examples, the interface 320 may include one or more channels or pipelines (e.g., ONFI channels) via which commands or data may be communicated. In some examples, the interface 320 may include one or more latches (e.g., sets of memory cells) that may be configured to temporarily store data retrieved from the planes 321-324 prior to being transferred to the memory system controller 315.

The memory system controller 315 may issue one or more sense commands 316 to the local controller 312 in response to which the local controller 312 may transfer respective data 325 to the interface 320, where each data 325 may be a respective portion of data stored across the planes and determined to be read by the memory system 301. For example, the local controller 312 may cause the data 325a-d from the planes 321-324, respectively, to be temporarily stored to latches of the interface 320. The memory system controller 315 may issue a transfer command 317 to the local controller 312 in response to which the local controller 312 may cause the data 325 to be transferred to the memory system controller 315 via the interface 320. The local controller 312 may initiate the data transfer from the plane 321 followed by a series of data transfers from the remaining planes 322-324 after each prior data transfer ends. That is, data 325a may be from the plane 321 may be transferred via the interface 320 followed by data 325b-d from the planes 322-324, respectively.

The data 325 from each of the planes may be transferred to the memory system controller 315 in response to the single transfer command 317. For example, the planes 321-324 may be organized into a sequence of planes according to which data may be read and written. Accordingly, the order of pages from which the data 325 may be sequentially read may be fixed and predictable (e.g., plane 321 followed by plane 322, and so on). The transfer command 317 may include an indication to automatically switch between the planes to transfer the data 325 to the memory system controller 315 in accordance with the sequence of the planes. As a result, the local controller 312 may cause, in response to the transfer command 317, the data 325a-d to be sequentially transferred to the memory system controller 315 via the interface 320 in accordance with the sequence (e.g., without reception of additional transfer commands 317 between transferring respective data 325 from retrieved from respective planes).

In some examples, the transfer (e.g., retrieval, sensing, reading) of the data 325 from subsequent planes to the interface 320 may follow the transfer of data 325 of a current plane to the memory system controller 315 via the interface 320. For example, data 325 may be transferred to the interface 320 from respective planes via a common (e.g., shared) data path 330. The local controller 312 may initially cause the data 325a to be transferred to the interface 320 via a data path 330 (e.g., data pipeline) in response to a sense command 316. In response to the transfer command 317, the local controller 312 may cause the data 325a to be transferred to the memory system controller 315 via the interface 320. After the transfer of the data 325a to the memory system controller 315, the local controller 312 may cause data 325 from the next plane (e.g., data 325b from plane 322) to be transferred to the interface 320 via the data path 330 (e.g., in response to the prior or different sense command 316) and then to the memory system controller 315 (e.g., in response to the prior transfer command 317), and so on for the subsequent planes.

In some examples, the transfer (e.g., retrieval, sensing, reading) of the data 325 from subsequent planes to the interface 320 may be concurrent with the transfer of data 325 of a current plane to the memory system controller 315 via the interface 320. For example, data 325 may be transferred to the interface 320 from respective planes via respective data paths 330, which may enable data 325 from a next plane to be loaded to the interface 320 while data 325 from a current plane is being transferred to the memory system controller 315. For instance, the local controller 312 may initially cause the data 325a to be transferred to the interface 320 via a first data path 330 (e.g., data pipeline) in response to a sense command 316 and to the memory system controller 315 in response to the transfer command 317. While the data 325a is being transferred to the memory system controller 315 (e.g., or the interface 320), the local controller 312 may cause data 325 from the next plane (e.g., data 325b from plane 322) to be transferred to the interface 320 via a second data path 330. That is, at least a portion of the data 325b may be transferred to the interface 320 via the second data path 330 concurrent with the data 325a being transferred to the memory system controller 315. The data 325b may then be transferred to the memory system controller 315, and so on for subsequent planes.

Such concurrent transfer of the data 325 may reduce a latency associated with reading the data 325 across the planes 321-324 and increase efficiency of the interface 320. For example, there may be a delay between the transfer of, for example, data 325a and data 325b to the memory system controller 315 associated with transferring the data 325b to the interface 320. For instance, if using a common data path 330, the data 325b may be delayed from being transferred to the interface 320 until after the data 325a is transferred to the memory system controller 315. The delay between the transfer of the data 325a and the data 325b to the memory system controller 315 may be the time taken to transfer the data 325b to the interface 320 after the transfer of the data 325a to the memory system controller 315. This time to transfer the data 325b to the interface 320 may be referred to as a tCCS duration. By concurrently transferring the data 325b to the interface 320 with the transfer of the data 325a to the memory system controller 315, the time, and thus the delay, between the end of the transfer of the data 325a to the memory system controller and the end of the transfer of the data 325b to the interface 320 may be reduced or eliminated.

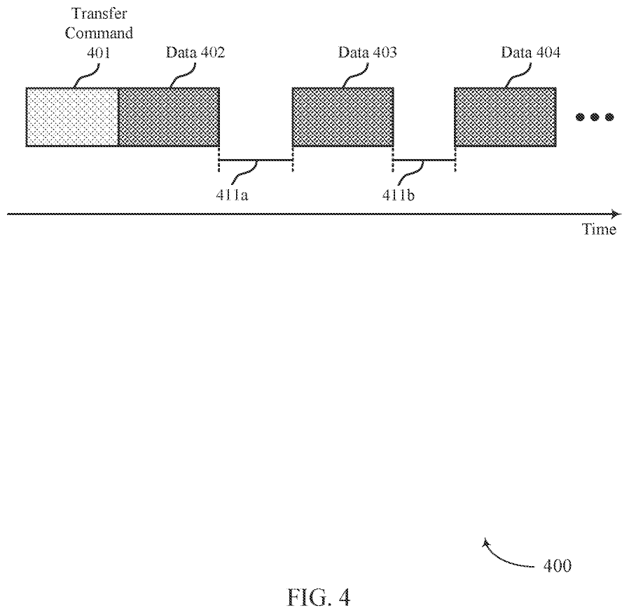

FIG. 4 illustrates an example of a command sequence 400 that supports multiplane data transfer commands in accordance with examples as disclosed herein. The command sequence 400 may be implemented by aspects of the systems 100, 200, and 3M) described with reference to FIGS. 1 through 3. For example, the command sequence 400 may be implemented by a memory system, such as a memory system described herein, including with reference to FIGS. 1 through 3.

In FIG. 4, timing of the transfers of the data 325a-d to the memory system controller 315 is shown corresponding to a transfer command 401 (e.g., a transfer command 317) and data transmitted between the memory system controller 315 and the memory device 302 as described in reference to FIG. 3. The timing illustrates the command sequence 400 begins with the transmission of the transfer command 401 from the memory system controller 315 to the local controller 312. In response to the transfer command 401, local controller 312 causes data 402 (e.g., data 325a) retrieved from the plane 321 to be transmitted to the memory system controller 315 followed by data 403 retrieved from the plane 322 data 404 retrieved from the plane 323, and so on, via the interface 320 (e.g., over one or more ONFI channels of the interface 320, over one or more data pipelines or data paths of the interface 320). This process may continue for each plane within the memory device 302 from which data is read to the memory system controller 315 as part of a sequential read operation (e.g., a series of sequential read operations).

Between the various transfers of the data 402-404, a respective time delay 411 (e.g., a tCCS duration) is shown. The time delays 411 (e.g., a time delay 411a between the transfer of data 402 and data 403, a time delay 411b between the transfer of data 403 and data 404, and so on) may include time to switch access to the interface 320 from one plane to another plane as well as the time for the data to be retrieved from the plane before the data may be transmitted (e.g., transferred) via the interface 320.

Use of a single transfer command 401 may reduce a latency associated with reading the data from the planes. For example, rather than requiring the local controller 312 to receive a transfer command to transfer data from a first plane 321 followed by a transfer command (e.g., a change column command) to switch from transferring data from the first plane 321 to transferring data from the second plane 322, and so on, the local controller 312 may receive a single transfer command 401 from the memory system controller 315 to initiate the entire data transfer from all of the planes 321-324. Thus, time used to communicate all of the individual commands to select a plane for transferring data and to initiate the data transfer may be replaced by the time used to communicate a single transfer command.

In some examples, use of a single transfer command 401 may also support the time delays 411 (e.g., tCCS) to be reduced or eliminated. For example, if the memory device 302 includes multiple data paths 330 between the planes 321-324 and the interface 320, the local controller 312 may initiate data transfer from a plane to the interface 320 while a prior data transfer from an earlier accessed plane to the memory system controller 315 in the sequence of data transfers is completing (e.g., ongoing). The retrieval of data from planes 321-324 may begin and the data transfer may be initiated after the interface 320 is enabled for the particular plane 321-324.

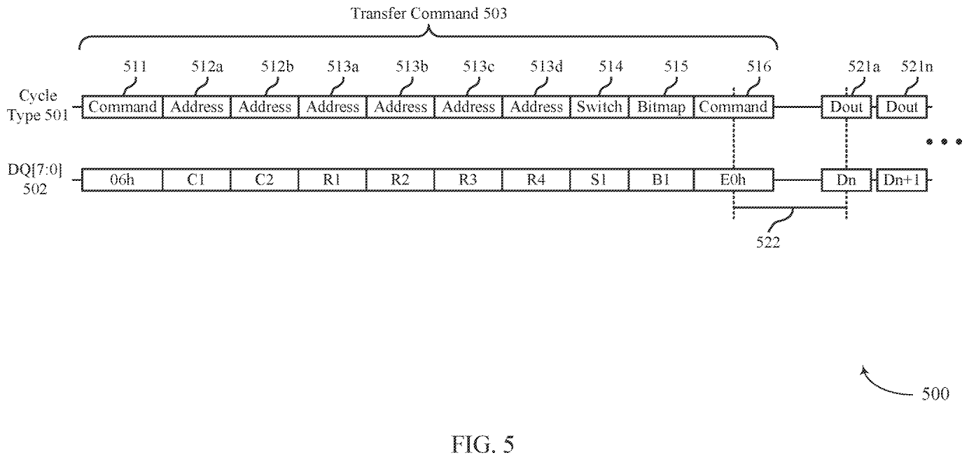

FIG. 5 illustrates an example of a data transfer diagram 500 that supports multiplane data transfer commands in accordance with examples as disclosed herein. The data transfer diagram 500 may be implemented by aspects of the systems 100, 200, and 300 described with reference to FIGS. 1 through 3. For example, the data transfer diagram 500 may be implemented by a memory system, such as a memory system described herein, including with reference to FIGS. 1 through 4.

The data transfer diagram 500 depicts a timing of a single transfer command 503 in response to which data retrieved from multiple planes may be transferred to the memory system controller 315. Timing of signals D[7:0] 502 and the corresponding cycle type 501 for the single transfer command 503 define data signals D[7:0] 502 into and out of a memory device 302 during the occurrence of a particular read operation.

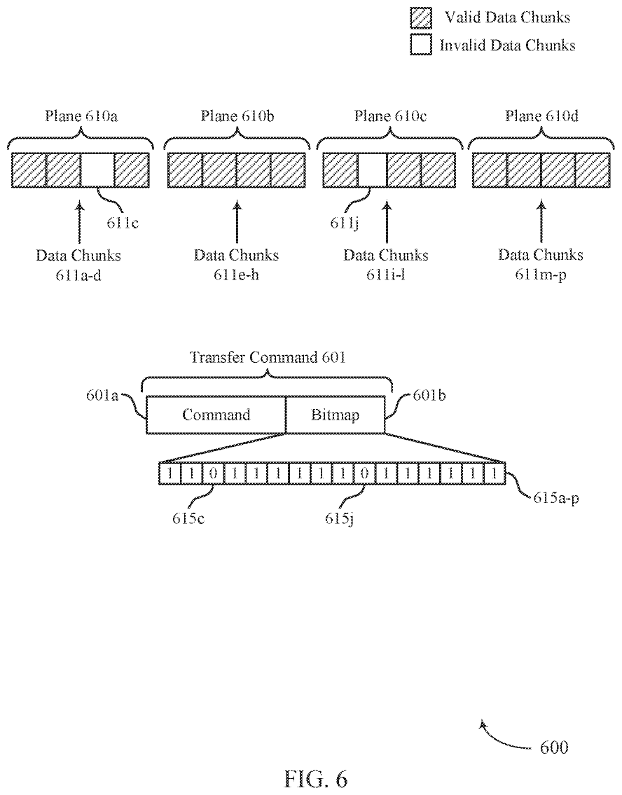

The transfer command 503 begins with the transmission of a command header (06h) 511 to initiate transmission of the read command. A pair of column addresses 512a-b (e.g., column address bytes) are transmitted over data signals D[7:0] 502 following the command header (06h) 511. Four row addresses 513a-d (e.g., row address bytes) are transmitted over data signals D[7:0] 502 following the column addresses 512a-b. In some examples, the address indicated by the transfer command 503 may be an address of a first plane of a sequence of planes from which corresponding data is transferred to the memory system controller 315. In some examples, the order of the sequence of planes may be based on (e.g., correspond to) an order in which the data was previously written to the planes. A switch indication 514 may be transmitted over one or more of the data signals D[7:0] 502 (e.g., depicted as following the row addresses 513, although the switch indication 514 may be included elsewhere within the transfer command 503). The switch indication 514 may indicate for the automatic switching between planes of the sequence of planes in accordance with the sequence. For example, the switch indication 514 may indicate to switch from a last column address of a current plane to a first column address of a next plane in the sequence in transferring the data to the memory system controller. In some examples, a bitmap 515 may be transmitted over one or more of the data signals D[7:0] 502 (e.g., depicted as following the switch indication 514, although the bitmap 515 may be included elsewhere within the transfer command 503). The bitmap 515 may indicate which chunks of the data 521 retrieved from the planes are to be transferred to the memory system controller 315 and which chunks of the data 521 are to be skipped. Additional details related to the transfer of data in accordance with the bitmap 515 are described with reference to FIG. 6 below. A command tail (E0h) 516 may end the transmission of the transfer command 503.

Data chunks retrieved from the memory device 302 is shown as a sequence of bytes 521a-n after a delay tCCS 522. As described herein, the tCCS delay 522 may correspond to a time taken to transfer (e.g., sense, retrieve, read) data from a plane (e.g., indicated in the transfer command 503) to the interface 320 after which the data may be transferred to the memory system controller 315. The delay tCCS 522 may be reduced if the local controller 312 begins this transfer from a second plane (e.g., a next plane of the sequence) as the data transfer from a first plane is completing (e.g., ongoing).

FIG. 6 illustrates an example of a data transfer diagram 600 that supports multiplane data transfer commands in accordance with examples as disclosed herein. The data transfer diagram 600 may be implemented by aspects of the systems 100, 200, and 300 described with reference to FIGS. 1 through 3. For example, the data transfer diagram 600 may be implemented by a memory system, such as a memory system described herein, including with reference to FIGS. 1 through 5.

The data transfer diagram 600 includes a transfer command 601 that includes a command portion 601a and a bitmap portion 601b. The command portion 601a may correspond to the portions of the transfer command 503 excluding the bitmap 515 described with reference to FIG. 5.

The bitmap portion 601b may correspond to a set of data chunks 611a-p within data retrieved in response to the transfer command 601 (e.g., or in response to one or more sense commands 316) that may be included and excluded from the data transferred to the memory system controller 315 in response to the transfer command 601. In the example of FIG. 6, the data transferred is obtained from four planes 610a-d (e.g., planes 321-324). The data from each memory plane is divided into four data chunks (although other quantities of data chunks are possible): plane 610a includes data chunks 611a-d, plane 610b includes data chunks 611e-h, plane 610c includes data chunks 611i-1, and plane 610d includes data chunks 611m-p. For example, the data transferred in the example of FIG. 6 may correspond to a pageline of data. That is, data from a page (e.g., page 175) of each plane 610 may be retrieved and transferred to the memory system controller 315. Each page may be divided into one or more data chunks 611. For examples, a page may include at least a first quantity of storage (e.g., 16 kilobyte (kB), among other quantities of storage). A translation unit may correspond to a data granularity associated with the type of memory system (e.g., a granularity at which data may be written, read, or both). For example, a translation unit may correspond to a second quantity of storage (e.g., 4 kB for UFS, 512 B for eMMC) from which data may be read or to which data may be written. In some examples, the translation units may represent a minimal amount of data pointed to by entries of a flash translation layer (FTL) table. In some cases, logical translation units (e.g., logical addresses of the translation units) may be used to indicate data at a logical level (e.g., at a host and controller level), and the translation units may be the physical locations at which the logical data is stored. In the example of FIG. 6, each data chunk 611 may correspond to a respective translation unit (e.g., a 4 kB chunk) of a page.

The memory system 301 (e.g., the memory system controller 315) may generate the bitmap portion 601b to include a bitmap 615a-p with a respective bit corresponding to each of the data chunks 611a-p. In the example of FIG. 6, a bit of the bitmap 615 having a value of ‘1’ (e.g., or ‘0’) may indicate that the corresponding data chunk 611a-p is included in the data transfer from the memory device 302 to the memory system controller 315. Alternatively, a bit of the bitmap 615 having a value of ‘0’ (e.g., or ‘1’) may indicate that the corresponding data chunk 611a-p is excluded from the data transfer from the memory device 302 to the memory system controller 315. For example, bitmap 615a-p may include bits having a value of ‘1’ for all bits except for bits 615c and 615j which have a value of ‘0’. Accordingly, in response to the transfer command 601 and in accordance with the bitmap 615a-p, the data chunks 611a-b, d-i, and k-p may be transferred to the memory system controller 315 and the data chunks 611c and 611j may be excluded from being transferred to the memory system controller 315.

In some examples, the bitmap 615a-p may correspond to data chunks 611a-p in which all of the data chunks contain valid data except for data chunk 611c and data chunk 611j. That is, the bitmap 615a-p may indicate which data chunks 611 include valid data and which data chunks 611 include invalid data. The data chunks 611 containing invalid data may be excluded from the data transfer to the memory system controller 315 in response to the transfer command 601.

In some examples, the bits of the bitmap 615 may indicate which planes are to be included and which planes are to be excluded in the transfer of data to the memory system controller 315. For example, the bitmap 615 may include a respective bit for each plane that indicates whether data from the plane is to be transferred in response to the transfer command 401. For instance, the memory system controller 315 may generate the transfer command 601 to include a bitmap 615 (e.g., a bit sequence of 1011) indicating that data from the planes 610 a, c, and d is to be transferred, while data from plane 610b is to be skipped. Accordingly, the memory system 301 (e.g., the local controller 312) may transfer the data chunks 611 of the planes 610 a, c, and d to the memory system controller 315 and refrain from transferring the data chunks 611 of the plane 610b to the memory system controller 315 in response to the transfer command 601.

In some examples, the bitmap 615 may indicate one or more planes 610 to exclude from the sequence of planes which may modify which plane is considered a next plane of the sequence. For example, if the bitmap 615 indicate to exclude the plane 610b from the sequence, the plane 610c may be considered a next plane 610 after the plane 610a. Accordingly, in accordance with the bitmap 615 and the transfer command 601, the memory system 301 may switch from the plane 610a directly to the plane 610c (e.g., from a last column address of the plane 610a to a first column address of the plane 610c) in transferring the data to the memory system controller 315.

FIG. 7 illustrates a block diagram 700 of a memory system 720 that supports multiplane data transfer commands in accordance with examples as disclosed herein. The memory system 720 may be an example of aspects of a memory system as described with reference to FIGS. 1 through 6. The memory system 720, or various components thereof, may be an example of means for performing various aspects of multiplane data transfer commands as described herein. For example, the memory system 720 may include a read component 725, a command component 730, a transfer component 735, an interface component 740, or any combination thereof. Each of these components may communicate, directly or indirectly, with one another (e.g., via one or more buses).

The read component 725 may be configured as or otherwise support a means for determining, at a memory system, to read data stored across a set of planes of a non-volatile memory device of the memory system. The command component 730 may be configured as or otherwise support a means for issuing, to a first controller of the non-volatile memory device based at least in part on the determination, a command to transfer portions of the data stored at respective planes of the set of planes to a second controller of the memory system. The transfer component 735 may be configured as or otherwise support a means for transferring, in response to issuing the command, a first portion of the data stored at a first plane of the set of planes to the second controller. In some examples, the transfer component 735 may be configured as or otherwise support a means for transferring, in response to issuing the command, a second portion of the data stored at a second plane of the set of planes to the second controller.

In some examples, the command component 730 may be configured as or otherwise support a means for issuing, to the first controller based on the determination, a second command to sense the data. In some examples, the interface component 740 may be configured as or otherwise support a means for transferring, in response to the second command, the first portion of the data from the first plane to an interface between the first plane and the second controller, where the first portion of the data is transferred to the second controller via the interface. In some examples, the interface component 740 may be configured as or otherwise support a means for transferring, in response to the second command, the second portion of the data from the second plane to the interface, where the second portion of the data is transferred to the second controller via the interface.

In some examples, to support transferring the second portion of the data from the second plane to the interface, the interface component 740 may be configured as or otherwise support a means for transferring at least part of the second portion of the data from the second plane to the interface concurrent with the first portion of the data being transferred to the second controller.

In some examples, the first portion of the data is transferred from the first plane to the interface via a first data path. In some examples, the second portion of the data is transferred from the second plane to the interface via a second data path. In some examples, the first data path corresponds to a first ONFI channel. In some examples, the second data path corresponds to a second ONFI channel.

In some examples, to support issuing the command, the command component 730 may be configured as or otherwise support a means for generating the command to include a bitmap that indicates chunks of the data including valid data and chunks of the data including invalid data, where one or more chunks of the first portion of the data or one or more chunks of the second portion of the data indicated as including invalid data are excluded from being transferred to the second controller in accordance with the bitmap.

In some examples, the chunks of the data including valid data correspond to respective translation units of the non-volatile memory device including valid data. In some examples, the chunks of the data including invalid data correspond to respective translation units of the non-volatile memory device including invalid data.

In some examples, to support issuing the command, the command component 730 may be configured as or otherwise support a means for generating the command to include a bitmap that indicates one or more planes of the set of planes to exclude as part of transferring the portions of the data to the second controller. In some examples, the transfer component 735 may be configured as or otherwise support a means for refraining from transferring respective portions of the data stored at the one or more planes to the second controller in accordance with the bitmap.

In some examples, the set of planes are organized into a sequence of planes. In some examples, the command includes an indication to automatically switch between the planes to transfer the portions of the data in accordance with the sequence. In some examples, the second portion of the data is transferred to the second controller after the first portion of the data based at least in part on the second plane being subsequent to the first plane in the sequence.

In some examples, the indication to switch between the planes indicates a switch from a last column address of a current plane to a first column address of a next plane in the sequence.

In some examples, the second command further includes a bitmap that indicates one or more planes of the set of planes to exclude from the sequence as part of transferring the portions of the data to the second controller, and the transfer component 635 may be configured as or otherwise support a means for refraining from transferring respective portions of the data stored at the one or more planes to the second controller in accordance with the bitmap.

FIG. 8 illustrates a flowchart showing a method 800 that supports multiplane data transfer commands in accordance with examples as disclosed herein. The operations of method 800 may be implemented by a memory system or its components as described herein. For example, the operations of method 800 may be performed by a memory system as described with reference to FIGS. 1 through 7. In some examples, a memory system may execute a set of instructions to control the functional elements of the device to perform the described functions. Additionally, or alternatively, the memory system may perform aspects of the described functions using special-purpose hardware.

At 805, the method may include determining, at a memory system, to read data stored across a set of planes of a non-volatile memory device of the memory system. The operations of 805 may be performed in accordance with examples as disclosed herein. In some examples, aspects of the operations of 805 may be performed by a read component 825 as described with reference to FIG. 7.

At 810, the method may include issuing, to a first controller of the non-volatile memory device based at least in part on the determination, a command to transfer portions of the data stored at respective planes of the set of planes to a second controller of the memory system. The operations of 810 may be performed in accordance with examples as disclosed herein. In some examples, aspects of the operations of 810 may be performed by a command component 730 as described with reference to FIG. 7.

At 815, the method may include transferring, in response to issuing the command, a first portion of the data stored at a first plane of the set of planes to the second controller. The operations of 815 may be performed in accordance with examples as disclosed herein. In some examples, aspects of the operations of 815 may be performed by a transfer component 735 as described with reference to FIG. 7.

At 820, the method may include transferring, in response to issuing the command, a second portion of the data stored at a second plane of the set of planes to the second controller. The operations of 820 may be performed in accordance with examples as disclosed herein. In some examples, aspects of the operations of 820 may be performed by a transfer component 735 as described with reference to FIG. 7.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for determining, at a memory system, to read data stored across a set of planes of a non-volatile memory device of the memory system; issuing, to a first controller of the non-volatile memory device based at least in part on the determination, a command to transfer portions of the data stored at respective planes of the set of planes to a second controller of the memory system; transferring, in response to issuing the command, a first portion of the data stored at a first plane of the set of planes to the second controller; and transferring, in response to issuing the command, a second portion of the data stored at a second plane of the set of planes to the second controller.

Aspect 2: The method, apparatus, or non-transitory computer-readable medium of aspect 1, further including operations, features, circuitry, logic, means, or instructions, or any combination thereof for issuing, to the first controller based at least in part on the determination, a second command to sense the data; transferring, in response to the second command, the first portion of the data from the first plane to an interface between the first plane and the second controller, where the first portion of the data is transferred to the second controller via the interface; and transferring, in response to the second command, the second portion of the data from the second plane to the interface, where the second portion of the data is transferred to the second controller via the interface.

Aspect 3: The method, apparatus, or non-transitory computer-readable medium of aspect 2, where transferring the second portion of the data from the second plane to the interface includes operations, features, circuitry, logic, means, or instructions, or any combination thereof for transferring at least part of the second portion of the data from the second plane to the interface concurrent with the first portion of the data being transferred to the second controller.

Aspect 4: The method, apparatus, or non-transitory computer-readable medium of aspect 3, where the first portion of the data is transferred from the first plane to the interface via a first data path and the second portion of the data is transferred from the second plane to the interface via a second data path.

Aspect 5: The method, apparatus, or non-transitory computer-readable medium of aspect 4, where the first data path corresponds to a first ONFI channel and the second data path corresponds to a second ONFI channel.

Aspect 6: The method, apparatus, or non-transitory computer-readable medium of any of aspects 1 through 5, where issuing the command includes operations, features, circuitry, logic, means, or instructions, or any combination thereof for generating the command to include a bitmap that indicates chunks of the data including valid data and chunks of the data including invalid data, where one or more chunks of the first portion of the data or one or more chunks of the second portion of the data indicated as including invalid data are excluded from being transferred to the second controller in accordance with the bitmap.

Aspect 7: The method, apparatus, or non-transitory computer-readable medium of aspect 6, where the chunks of the data including valid data correspond to respective translation units of the non-volatile memory device including valid data and the chunks of the data including invalid data correspond to respective translation units of the non-volatile memory device including invalid data.

Aspect 8: The method, apparatus, or non-transitory computer-readable medium of any of aspects 1 through 5, where issuing the command includes operations, features, circuitry, logic, means, or instructions, or any combination thereof for generating the command to include a bitmap that indicates one or more planes of the set of planes to exclude as part of transferring the portions of the data to the second controller, the method, apparatus, or non-transitory computer-readable medium further including operations, features, circuitry, logic, means, or instructions, or any combination thereof for refraining from transferring respective portions of the data stored at the one or more planes to the second controller in accordance with the bitmap.

Aspect 9: The method, apparatus, or non-transitory computer-readable medium of any of aspects 1 through 8, where the set of planes are organized into a sequence of planes; the command includes an indication to automatically switch between the planes to transfer the portions of the data in accordance with the sequence; and the second portion of the data is transferred to the second controller after the first portion of the data based at least in part on the second plane being subsequent to the first plane in the sequence.

Aspect 10: The method, apparatus, or non-transitory computer-readable medium of aspect 9, where the indication to switch between the planes indicates a switch from a last column address of a current plane to a first column address of a next plane in the sequence.

Aspect 11: The method, apparatus, or non-transitory computer-readable medium of any of aspects 9 through 10, where the command further includes a bitmap that indicates one or more planes of the set of planes to exclude from the sequence as part of transferring the portions of the data to the second controller and the method, apparatuses, and non-transitory computer-readable medium further includes operations, features, circuitry, logic, means, or instructions, or any combination thereof for refraining from transferring respective portions of the data stored at the one or more planes to the second controller in accordance with the bitmap.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and second condition or action may occur directly as a result of the previous condition or action occurring independent of whether other conditions or actions occur. In some examples, a first condition or action may be performed, and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A. B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a non-volatile memory device comprising a first controller; and
a second controller coupled with the non-volatile memory device, wherein the second controller is configured to cause the apparatus to:
determine to read data stored across a set of planes of the non-volatile memory device;
issue, to the first controller based at least in part on the determination, a command to transfer portions of the data stored at respective planes of the set of planes to the second controller;
transfer, in response to issuing the command, a first portion of the data stored at a first plane of the set of planes to the second controller; and
transfer, in response to issuing the command, a second portion of the data stored at a second plane of the set of planes to the second controller.

2. The apparatus of claim 1, wherein the second controller is further configured to cause the apparatus to:
issue, to the first controller based at least in part on the determination, a second command to sense the data;
transfer, in response to the second command, the first portion of the data from the first plane to an interface between the first plane and the second controller, wherein the first portion of the data is transferred to the second controller via the interface; and
transfer, in response to the second command, the second portion of the data from the second plane to the interface, wherein the second portion of the data is transferred to the second controller via the interface.

3. The apparatus of claim 2, wherein, to transfer the second portion of the data from the second plane to the interface, the second controller is configured to cause the apparatus to:
transfer at least part of the second portion of the data from the second plane to the interface concurrent with the first portion of the data being transferred to the second controller.

4. The apparatus of claim 3, wherein:
the first portion of the data is transferred from the first plane to the interface via a first data path, and
the second portion of the data is transferred from the second plane to the interface via a second data path.

5. The apparatus of claim 1, wherein, to issue the command, the second controller is configured to cause the apparatus to:
generate the command to include a bitmap that indicates chunks of the data comprising valid data and chunks of the data comprising invalid data,
wherein one or more chunks of the first portion of the data or one or more chunks of the second portion of the data indicated as comprising invalid data are excluded from being transferred to the second controller in accordance with the bitmap.

6. The apparatus of claim 1, wherein, to issue the command, the second controller is configured to cause the apparatus to:
generate the command to include a bitmap that indicates one or more planes of the set of planes to exclude as part of transferring the portions of the data to the second controller, wherein the second controller is further configured to cause the apparatus to:
refrain from transferring respective portions of the data stored at the one or more planes to the second controller in accordance with the bitmap.

7. The apparatus of claim 1, wherein:
the set of planes are organized into a sequence of planes,
the command comprises an indication to automatically switch between the planes to transfer the portions of the data in accordance with the sequence, and
the second portion of the data is transferred to the second controller after the first portion of the data based at least in part on the second plane being subsequent to the first plane in the sequence.

8. The apparatus of claim 7, wherein the indication to switch between the planes indicates a switch from a last column address of a current plane to a first column address of a next plane in the sequence.

9. The apparatus of claim 7, wherein the command further comprises a bitmap that indicates one or more planes of the set of planes to exclude from the sequence as part of transferring the portions of the data to the second controller, and the second controller is further configured to cause the apparatus to:
refrain from transferring respective portions of the data stored at the one or more planes to the second controller in accordance with the bitmap.

10. A non-transitory computer-readable medium storing code comprising instructions which, when executed by a processor of an electronic device, cause the electronic device to:
determine, at a memory system, to read data stored across a set of planes of a non-volatile memory device of the memory system;
issue, to a first controller of the non-volatile memory device based at least in part on the determination, a command to transfer portions of the data stored at respective planes of the set of planes to a second controller of the memory system;
transfer, in response to issuing the command, a first portion of the data stored at a first plane of the set of planes to the second controller, and
transfer, in response to issuing the command, a second portion of the data stored at a second plane of the set of planes to the second controller.

11. The non-transitory computer-readable medium of claim 10, wherein the instructions, when executed by the processor of the electronic device, further cause the electronic device to:
issue, to the first controller based at least in part on the determination, a second command to sense the data;
transfer, in response to the second command, the first portion of the data from the first plane to an interface between the first plane and the second controller, wherein the first portion of the data is transferred to the second controller via the interface; and
transfer, in response to the second command, the second portion of the data from the second plane to the interface, wherein the second portion of the data is transferred to the second controller via the interface.

12. The non-transitory computer-readable medium of claim 11, wherein the instructions to transfer the second portion of the data from the second plane to the interface, when executed by the processor of the electronic device, further cause the electronic device to:
transfer at least part of the second portion of the data from the second plane to the interface concurrent with the first portion of the data being transferred to the second controller.

13. The non-transitory computer-readable medium of claim 12, wherein:
the first portion of the data is transferred from the first plane to the interface via a first data path, and
the second portion of the data is transferred from the second plane to the interface via a second data path.

14. The non-transitory computer-readable medium of claim 10, wherein the instructions to issue the command, when executed by the processor of the electronic device, further cause the electronic device to:
generate the command to include a bitmap that indicates chunks of the data comprising valid data and chunks of the data comprising invalid data, wherein one or more chunks of the first portion of the data or one or more chunks of the second portion of the data indicated as comprising invalid data are excluded from being transferred to the second controller in accordance with the bitmap.

15. The non-transitory computer-readable medium of claim 10, wherein the instructions to issue the command, when executed by the processor of the electronic device, further cause the electronic device to:
generate the command to include a bitmap that indicates one or more planes of the set of planes to exclude as part of transferring the portions of the data to the second controller, wherein the instructions, when executed by the processor of the electronic device, further cause the electronic device to:
refrain from transferring respective portions of the data stored at the one or more planes to the second controller in accordance with the bitmap.

16. The non-transitory computer-readable medium of claim 10, wherein:
the set of planes are organized into a sequence of planes,
the command comprises an indication to automatically switch between the planes to transfer the portions of the data in accordance with the sequence, and
the second portion of the data is transferred to the second controller after the first portion of the data based at least in part on the second plane being subsequent to the first plane in the sequence.

17. The non-transitory computer-readable medium of claim 16, wherein the indication to switch between the planes indicates a switch from a last column address of a current plane to a first column address of a next plane in the sequence.

18. The non-transitory computer-readable medium of claim 16, wherein the command further comprises a bitmap that indicates one or more planes of the set of planes to exclude from the sequence as part of transferring the portions of the data to the second controller, and wherein the instructions, when executed by the processor of the electronic device, further cause the electronic device to:
refrain from transferring respective portions of the data stored at the one or more planes to the second controller in accordance with the bitmap.

19. A method, comprising:
determining, at a memory system, to read data stored across a set of planes of a non-volatile memory device of the memory system;
issuing, to a first controller of the non-volatile memory device based at least in part on the determination, a command to transfer portions of the data stored at respective planes of the set of planes to a second controller of the memory system;
transferring, in response to issuing the command, a first portion of the data stored at a first plane of the set of planes to the second controller; and
transferring, in response to issuing the command, a second portion of the data stored at a second plane of the set of planes to the second controller.

20. The method of claim 19, further comprising:
issuing, to the first controller based at least in part on the determination, a second command to sense the data;
transferring, in response to the second command, the first portion of the data from the first plane to an interface between the first plane and the second controller, wherein the first portion of the data is transferred to the second controller via the interface; and
transferring, in response to the second command, the second portion of the data from the second plane to the interface, wherein the second portion of the data is transferred to the second controller via the interface.
